(19) United States
(12) Patent Application Publication
(10) Pub. No.: US 2025/0126072 A1
(43) Pub. Date: Apr. 17, 2025

(54) Time Critical Packet Transmission

(71) Applicant: TEXAS INSTRUMENTS INCORPORATED, Dallas, TX (US)

(72) Inventors: Liangcheng Tao, Plano, TX (US); Robert Liang, Frisco, TX (US); Kumaran Vijayasankar, Allen, TX (US)

(21) Appl. No.: 18/904,086

(22) Filed: Oct. 2, 2024

Related U.S. Application Data
(60) Provisional application No. 63/589,431, filed on Oct. 11, 2023.

(51) Int. Cl. H04L 47/62; H04L 47/80; H04L 69/22; H04L 101/622

(52) U.S. Cl. CPC H04L 47/6215; H04L 47/805; H04L 69/22; H04L 2101/622

(57) ABSTRACT

Systems, methods, and computer program products provide for time critical packet transmission. An electronic device may include a transceiver and a processor that is configured to receive or transmit, via the transceiver, a plurality of packets having respective headers conforming to a layer below a network layer, and the first header of a first packet of the plurality of packets may include a source address and a hop limit field. The packet may be transmitted according to the layer below the network layer, thereby providing a smaller packet.

### CROSS-REFERENCE TO RELATED APPLICATIONS

This application claims the benefit of U.S. Provisional Patent Application 63/589,431, filed Oct. 11, 2023, the disclosure of which is incorporated herein by reference.

### TECHNICAL FIELD

The present disclosure relates generally to electronic systems and associated methods, and, in particular embodiments, to time critical packet transmissions.

### BACKGROUND

In some networks, unicast and broadcast messages are restricted to unicast and broadcast dwell time slots, respectively. Thus, a broadcast message may have to wait for a broadcast dwell time before it can be sent. If there is not enough time to send the broadcast message within the broadcast slot, then the broadcast message may get shifted to the next broadcast dwell time.

### SUMMARY

In accordance to an embodiment, a method includes: formatting data into a packet that includes: a medium access control (MAC) header and a payload, the MAC header having a source MAC address and an identifier of a hop limit; and transmitting the packet.

In accordance to an embodiment, an electronic device includes: a transceiver; and a processor configured to: receive or transmit, via the transceiver, a first plurality of packets having respective network-layer headers each including a respective first hop limit field; and receive or transmit, via the transceiver, a second plurality of packets having respective first headers conforming to a layer below the network layer, where the first header of a first packet of the second plurality of packets includes a source address, and a second hop limit field.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is an illustration of an example broadcast channel hopping sequence of an un-slotted Channel hopping medium access control (MAC), according to some embodiments;

FIG. 2 is an illustration of an example broadcast channel hopping sequence of an un-slotted Channel hopping MAC, according to some embodiments;

FIG. 3 is an illustration of an example time domain operation in a channel hopping network, according to some embodiments;

FIG. 4 is an illustration of an example time domain operation in a channel hopping network, according to some embodiments;

FIG. 5 is an illustration of two example packets, which may be used in a network, according to some embodiments;

FIG. 6 is an illustration of an example packet, which may be used in a network, according to some embodiments;

FIG. 7 is an illustration of an example time domain operation in a channel hopping network, according to some embodiments;

FIG. 8 is an illustration of a time domain operation in a channel hopping network, according to some embodiments;

FIG. 9 is an illustration of an arrangement of devices in a network, such as a channel hopping network, according to some embodiments;

FIG. 10 is an illustration of an example wireless device, which may be used in an example channel hopping network, according to some embodiments;

FIG. 11 is an illustration of an example system, which may be adapted for use in a channel hopping network, according to some embodiments; and

FIG. 12 is an illustration of an example method, according to some embodiments.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

The description below illustrates various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

In some applications that broadcast messages in dedicated broadcast dwell time slots, it is acceptable to have a long latency, e.g., when messages are forced to wait one or more broadcast dwell times. However, in some applications, a delay in broadcast transmission may be undesirable or even forbidden.

Some embodiments relate to time critical packet transmissions, such as packet transmissions having a latency constraint. Some embodiments, relate to transmission of packets having a format that includes at least a hop limit field in a layer below a network layer.

Embodiments of the present disclosure will be described in specific contexts, e.g., a method for transmission of time critical packets using a multi-hop, unsynchronized channel hopping network, such as a network based on Wi-SUN, for applications, such as, solar panel applications. Some embodiments may be used in other types of networks, such as other types of mesh networks and on networks without channel hopping. Some embodiments may be used in applications different from solar panels, such as any other application that may benefit from broadcast transmission of packets with a latency constraint.

Channel Hopping is a feature by which a node hops or moves to different channels (frequency bands). The channel hopping behavior can be used to achieve increased network throughput by promoting simultaneous data transfer over multiple channels between different pairs of nodes or to achieve reliability in tough channel conditions by exploiting the channel diversity.

Channel hopping may be achieved through many different methods. Common methods include: a synchronous method, also referred to as Time Slotted Channel Hopping (TSCH), and an asynchronous method, also referred to as un-slotted channel hopping, e.g., as defined in IEEE 802.15.4. Many standards exist that use such channel hopping medium access control (MAC) to define MAC protocols for different applications. For example, the Wi-SUN Alliance has proposed a Field Area Network (FAN) specification that specifies how to use TSCH for smart grid applications. Wi-SUN may use PHY speeds that range from 50 kbps to 2.4 Mbps, with some Wi-SUN use cases requiring lower data rates (e.g., such as 50 kbps), e.g., to provide improved range coverage. Some embodiments relate to unslotted channel hopping based MAC, such as Wi-SUN.

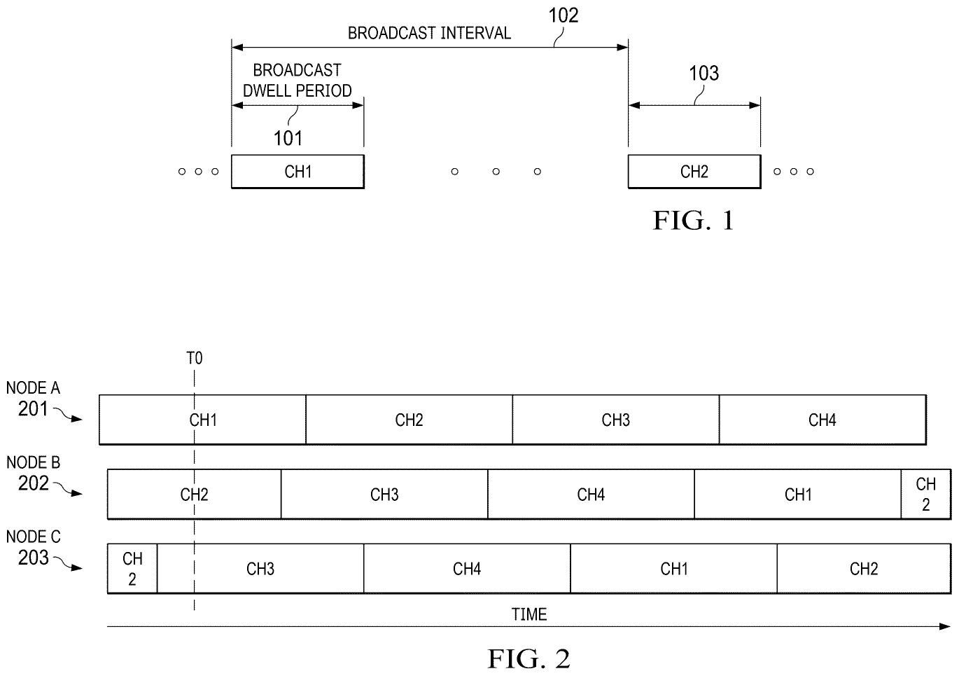

FIG. 1 illustrates a broadcast channel hopping sequence of an unslotted channel hopping MAC, according to some embodiments. In some unslotted channel hopping MACs, such as Wi-SUN FAN, each node follows the entire network's broadcast channel sequence, and all nodes listen on the same channel during the broadcast dwell period. Devices only transmit broadcast data during such broadcast dwell periods (e.g., dwell period 101) and all other devices in listening range may receive the broadcast data as they have their receiver tuned to the same channel (e.g., channel 1) as well.

During the broadcast interval 102, after the broadcast dwell period 101, the nodes follow their own receiver-directed unicast channel hopping schedules. If a device intends to transmit a packet to a particular receiver, the device sends the packet in the current unicast channel associated with the intended receiver, e.g., using carrier-sense multiple access with collision avoidance (CSMA/CA). A broadcast dwell period 103 is also illustrated for channel 2.

It is understood that although FIG. 1 shows channel 1 associated with broadcast dwell time period 101, and channel 2 associated with the next broadcast dwell period 103, the channels need not be sequential. For example, in some embodiments, the channels to be used in each broadcast dwell period may be selected, e.g., based on a (e.g., pseudo-random) channel hopping sequence. In some embodiments, the same channel may be used for all broadcast dwell periods. In some embodiments, channels 1 and 2 are adjacent in frequency, while, in other embodiments, channel 1 and channel 2 may not be adjacent in frequency, and may have at least one channel associated with a frequency that is between the frequencies of channels 1 and 2. Other implementations are also possible.

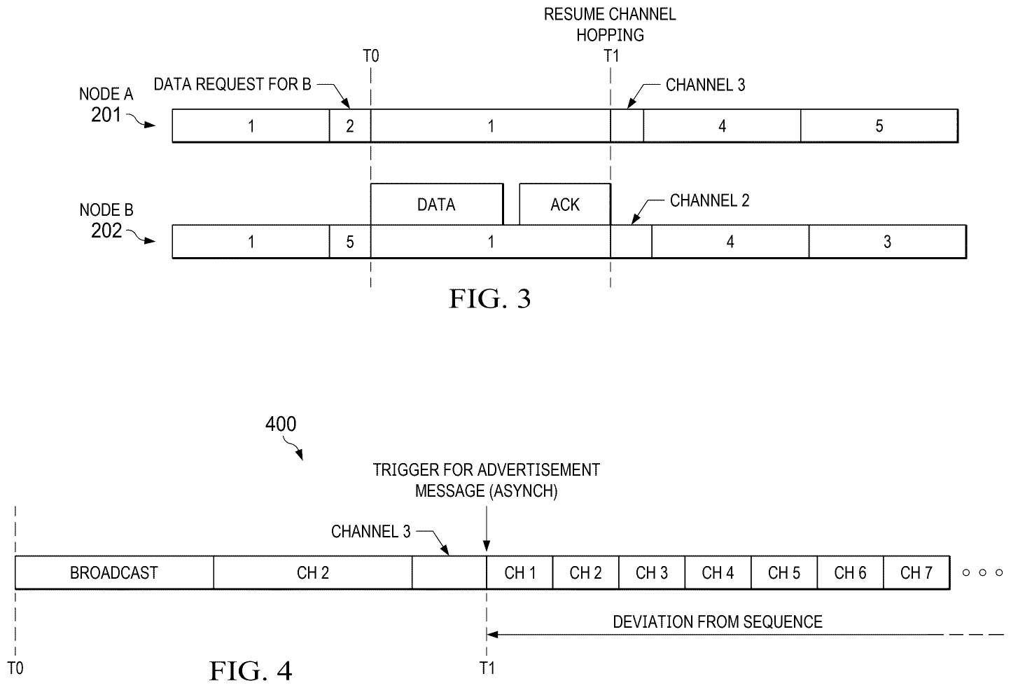

In some embodiments, the unicast channel hopping slots need not be synchronized to each other, e.g., as illustrated in FIG. 2. For example, FIG. 2 unicast channel hopping slots for Nodes A, B, C, which may occur during the broadcast interval after the broadcast dwell period. As shown in FIG. 2, at time TO, Node A is at a channel hopping slot for channel 1, Node B is at a channel hopping slot for channel 2, and Node C is at a channel hopping slot for channel 3. In fact, Node A has a channel hopping sequence 201, which is different from the channel hopping sequence 202 of Node B, which is different from the channel hopping sequence 203 of Node C. If the data transmission goes beyond the slot period then the node may continue the data transmission to the adjacent slot(s), e.g., as shown in FIG. 3.

In the example of FIG. 3, Node A transmits in Node B's channel 5 and the data transfer extends to the adjacent slot. For example, in FIG. 3, Node A begins transmitting at time TO in Node B's channel 5, and that transmission extends until time T1. Between times TO and T1, Node B would have transitioned from a slot for channel 5 to a slot for channel 2, but both Node A and Node B continue transmitting and receiving without switching channels during that span of time. In this particular example, Node A transmits data (Data), and upon receipt of the data, Node B transmits and acknowledgment (ACK). The channel hopping information may be exchanged between nodes through transfer of special information elements, e.g., as presented in the Wi-SUN FAN specification.

The exchange of information (e.g., timing information) may employ specific information elements as defined in the Wi-SUN FAN specification (e.g., version 1.0), such as the unicast timing information element (UTT-IE), and the unicast schedule information element (US-IE). The UTT-IE may carry the timing information to be used by a receiving node to track the transmitting node's channel hopping sequence. The US-IE may carry the information with regard to the channel number on which a node is currently listening (for nodes with fixed hopping) or the list of hopping channels, sequence and corresponding hopping pattern.

The examples illustrated in FIGS. 1-3 offer broadcast and unicast communication schemes. For example, to support broadcast, a central “Parent Node” may be used to transmit packets with timing information that is used for synchronization among all nodes to maintain a common broadcast schedule.

Apart from broadcast and unicast transmissions, networks such as a Wi-SUN network, may additionally support an asynchronous transmission method. Such transmissions may be initiated by a device at any point of time irrespective of unicast or broadcast dwell times. In this transmission method, a device sends the frame back-to-back on multiple (e.g., all) channels, as illustrated in FIG. 4. FIG. 4 illustrates an example time domain operation 400, which may be performed by a node in a network. For instance, the sequence begins at time TO, in which a broadcast interval for channel 1 also begins. The sequence then goes to channel 2 and channel 3. During the channel 3 broadcast interval, at time T1, the node begins asynchronous transmission, which deviates from the channel hopping sequence. For instance, the node may transmit an asynchronous message beginning at time T1 on channel 1, during a time that would have otherwise been used for channel 3. The node then transmits the same asynchronous message in channel 2, then channel 3, and on and on. Such frames are sent with an expectation of reaching all nodes irrespective of their current receiving channel. These frames may be used during the initial network discovery and for exchanging configuration data across the network.

In some networks, such as Wi-SUN, the unicast and broadcast messages are restricted to unicast and broadcast dwell time slots respectively. Thus, a broadcast message is expected to wait for a broadcast dwell time before it can be sent. If there is not enough time to send the message within the slot, the message transmission may be postponed to the next broadcast dwell time. This can cause significant delays for broadcast transmissions. In the case of Wi-SUN, such delays may be acceptable, e.g., for most Wi-SUN specific frames.

In some networks, it may be advantageous or even required to convey specific information (e.g., a time critical packet) to all nodes in the network within a specified time delay. For example, in some solar panel applications, excess power may be delivered to the grid. There may be times in which the grid cannot absorb the excess power. In some such times, it may be beneficial to be able to transmit a request (e.g., by a utility or other user) to immediately reduce power generation of the solar panel, and for such request to take effect within a predetermined time (e.g., 1 second, 150 ms, etc.).

In an exemplary implementation having 50 solar panels (50 network nodes) nodes spread over 2-3 hops, then to convey this information to all 50 nodes within a time period ‘x’, various methods may be used. For example, when using individual unicast transmissions, the time to reach all nodes may be given by: 50*unicast message latency per hop*average unicast message latency. As another example, when using asynchronous frames, the time to reach all nodes may be given by: total number of channels*packet transmission time*avg number of hops*average wait time between devices. As yet another example, when using broadcast frames, the time to reach all nodes may be given by: broadcast interval*average number of hops.

When x is relatively low, some the methods may not be able to guarantee delivery with the time period x, in some scenarios. For example, in a scenario in which x is 80 ms and the typical packet transmission time is 10 ms, using individual unicast transmissions or using asynchronous frames may not meet the 80 ms transmission in some networks. In the present example, all 50 nodes may not be able to be reached within 80 ms using the broadcast method either because of the time between broadcast dwell intervals, the use of methods to limit broadcast storm, such as Multicast Protocol for Low-Power and Lossy Networks (MPL), packet collisions and losses from a wireless network, and/or asynchronous transmissions from other devices which either make such broadcast transmission fail or cause the transmitting devices not to be in listening mode causing the packet reception to fail.

For example, Wi-SUN is based on IPv6 and Multicast Protocol for Low-Power and Lossy Networks (MPL) to support broadcast data packet transmissions. An MPL protocol goal is to limit broadcast storms and for frames to reach destinations reliably. The way it is achieved is by using trickle timers that are on the order of several seconds to stagger the broadcast frame transmissions, using an incoming broadcast frame as an indicator to decide whether to further re-broadcast the frame or not and also to add retries to improve reliability. The protocol may thus require several seconds to 10s of seconds to get a broadcast frame from a border router to reach all devices in the network. Such a protocol may not be scalable to lower latency requirements as it is limited by the underlying Wi-SUN MAC's ability to send broadcast frames and the need for trickle windows to be large enough to hear transmissions from neighboring devices.

Some embodiments are advantageously capable of transmitting a (e.g., time critical) frame from a central device(s) to all devices, within a predetermined time limit, in networks such as a Wi-SUN-based network. For example, to transmit time critical frames within a predetermined time limit, some embodiments may use one or more of:
limiting the packet size, at MAC level, for time critical frames;
using reserved time critical slots for time critical frames;
using backoff slots to prioritize packets across different packet types and devices;
using pre-configured or in-packet specified selective forwarding;
prioritizing time critical packets;
limiting asynchronous frame transmission based on reserved slots or incoming time critical frames; and/or
enabling unicast packets to be sent during broadcast slots and use only broadcast hopping for entire network.

In the following discussion, broadcast frames may be referred to as packets, and that term is used to include both packets and frames for ease of understanding.

IPv6-based protocols, such as Wi-SUN, generally account for user datagram protocol (UDP) and Internet protocol (IP) overhead (including the MPL protocol's overhead) in all data packets. Such overhead may add, e.g., 50-100 bytes to the payload. By contrast, in some scenarios, time critical data is only on the order of a few bytes.

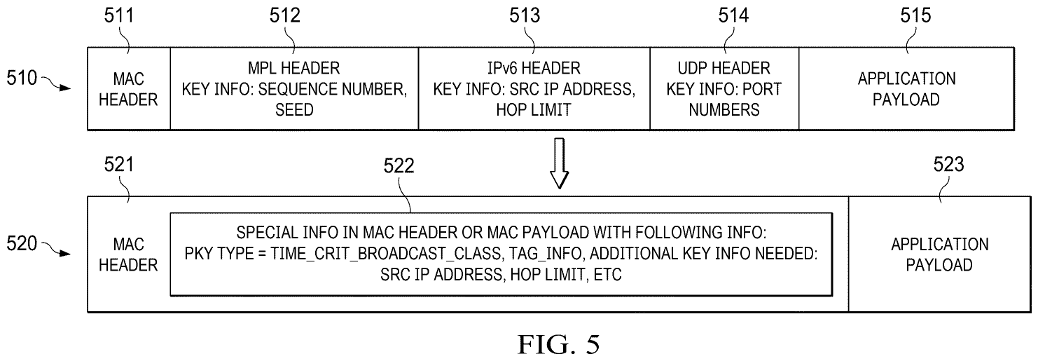

FIG. 5 illustrates a first packet 510 of Wi-SUN. As shown, there is a MAC header 511, an MPL header 512, an IPv6 header 513, a UDP header 514, and an application payload 515. As shown in FIG. 5, the packet 510 has four headers but only a few of them may be important for time critical packets from an application and network stack perspective. Note, e.g., that the hop limit in packet 510 is included in the IP header 513. In other words, the packet 510 relies upon IP-level routing, and IP-level routing functionality may be configured to reduce the hop limit each time the packet 510 is forwarded from one node to another node, ceasing to forward once the hop limit reaches a pre-defined quantity, such as zero. The table below shows fields of an example Wi-SUN packet as well a brief description of some of the information relevant to a time critical packet.

| Type | Average Size | Information relevant to a time critical packet |
|---|---|---|
| UDP header | ~16 bytes | Port Number |
| IP Header | ~40-80 bytes | Src IP address (other fields like destination may |
| | (if tunneling is | not be used in time critical packets as they are |
| | included) | intended for all nodes in the network) |
| | | Hop limit → to help limit how many times a |
| | | packet may be re-broadcasted/forwarded |
| MPL | ~16 bytes | Seed and Sequence number to keep track |
| Header | | of broadcast packets |
| MAC | ~20 bytes | All may be used by time critical packets, e.g., |
| Header | | for security and MAC level transmissions |

In some embodiments, packet overhead is reduced while keeping backward compatibility with IP packets. For example, some embodiments may add a special field/payload type in a MAC header or as part of a MAC payload that can represent the information in a more efficient manner. Some embodiments may use a tag representing different information previously received from the IP and transport headers and only add e.g., required additional information into a vendor payload information element or other MAC-level information.

FIG. 5 illustrates the format of an example time critical packet 520, according to an embodiment. As shown in FIG. 5, information from some of the different headers 511-514 is included in field 522 inside the MAC header 521. The table below shows fields of the example time critical packet 520 and a respective brief description.

| Type | Field | Info |
|---|---|---|
| MAC header | Retain all Wi-SUN MAC | Informs receiver to treat this packet |
| | Header files with | differently |
| | PKT_TYPE alone set to | |
| | TIME_CRIT_PKT | |
| Special | TAG | This uniquely represents/identifies |
| TIME_CRITICAL_ | | how rest of information element (IE) is |
| PKT_INFO_ | | formatted and may be used to |
| ELEMENT | | determine how the packet may be re- |
| | | constructed before sending the to |
| | | application layer |
| | Source (Src) IP address | To identify the sender (source) |
| | Hop Limit | How many times to rebroadcast the |
| | | packet |

In some embodiments, various aspects of time critical packets, such as illustrated in FIG. 5, may be handled in various ways. For example, in some embodiments, the TIME_CRITICAL_PKT_INFO_ELEMENT field 522 may be part of a vendor payload IE or any other information elements as defined in IEEE 802.15.4e. In some embodiments, the packet type may be defined as part of the UTT-IE packet type info field by using any of the reserved fields. In some embodiments, the actual number of bytes used for each of these fields may be modified for size versus time criticality for a given use case. For example, TAG field (in field 522) of length 2 bits may allow for 4 possible different combination of fields that may be used. Such a TAG is different from Context Ids used in IPv6 header compression in the sense that this TAG spans across network protocol stack layers (e.g., MPL header, IPv6 header, UDP header).

In some embodiments, the receiver, in response to receiving packet 520, may reconstruct the packet as if packet 520 have been received with headers 511-514 to ensure transparency to the application layer. Such reconstruction may be possible, e.g., based on the TAG selection and pre-stored information associated with such TAG selection.

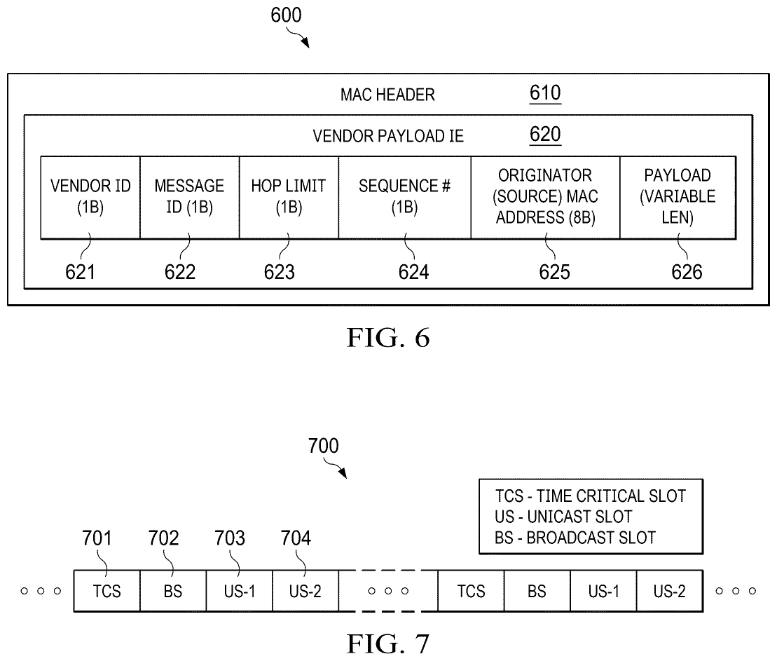

FIG. 6 is an illustration of another example time critical packet 600, according to some embodiments. In the example of FIG. 6, packet 600 includes MAC header 610, and the entirety of the information of packet 600 is included within MAC header 610. For instance, there is a vendor payload field 620, and it is encapsulated within MAC header 610. In some embodiments, fields 621-626 are encapsulated within vendor payload field 620 and, thus, encapsulated within MAC header 610.

Vendor payload 620 in some implementations may include a field that is defined by Wi-SUN for use by various manufacturers of products that implement Wi-SUN protocols. For instance, a given manufacturer may include its assigned identification in the vendor ID field 621.

In one example, the vendor ID field 621 may include one byte. A device receiving packet 600 may be configured to parse packet 600 to read the vendor ID field 621, and the vendor ID field 621 may inform the device as to how to interpret the fields 622-626. For instance, a different vendor ID in vendor ID field 621 may implement other fields (not shown) in a different way or a different quantity of fields.

Field 622 includes a message identification, which may be one byte in some implementations. The message ID field 622 and the sequence number field 624 may be utilized to identify a particular message among various messages that may be being broadcast at the same time or during an overlapping portion of time. For example, various devices in the network may be configured to compare a message ID field 622 and a sequence number field 624 in a newly-received packet to similar fields in other packets that have been recently processed, thereby helping to prevent flooding. For instance, if a packet is revealed to be a duplicate packet by analyzing fields 622 and 624, a device may drop that packet.

Hop limit field 623 in this example is one byte long. Hop limit field 623 may be configured in a same or similar manner as the hop limit given in field 522 of FIG. 5. Specifically, a hop limit at the MAC layer may denote a maximum quantity of remaining retransmissions (or hops) for the packet. A node may receive a packet (e.g., 520 or 600) and parse the field 623 to determine a quantity of remaining hops. Assuming that the quantity of remaining hops is not zero, then the node may decrement the value in the field 623 and re-broadcast packet 600 with the decremented hop limit to a next device (or multiple next devices). If the quantity of remaining hops is zero, then the device may omit further broadcasting the packet.

Field 625 in this instance may be eight bytes long, and it may identify a source address in the MAC layer of a source device. A source device may include, e.g., another device in the network, such as a border router or another router one or more hops away from the border router. Note that in this instance the source address is a MAC-layer source address, rather than a source address for a higher layer in the protocol stack (e.g., IP layer). By contrast, the packets 510 and 520 indicate a source address in the IP layer. A receiving device may use a source address, whether in the MAC layer or another layer, to respond to the source if appropriate.

Variable length payload field 626 may provide any appropriate data. In some instances, the packets 520 and 600 may be used for controlling devices, such as solar panel inverters. In such examples, payload field 626 (or application payload field 523) may be used to carry data to indicate to a receiving device to shut down or to reduce a power output (e.g., current and/or voltage). Accordingly, a given device, upon parsing the field 626 or 523, may determine that the field 626 or 523 indicates an action to be taken, such as shutting down or reducing the power output. The device may then take the action indicated by the field 626 or 523. This may be true whether the hop limit has been decremented to zero or not. In some instances, the action to be taken may be directed to only one device or perhaps a subset of devices, and affected devices may be identified in the payload 626 or 523 if appropriate.

In some implementations, the payload field 626 may be used to identify packet 600 as being time critical. The same is true of field 522 of FIG. 5.

Of course, the particular fields of packets 520 and 600 are for example, and other time critical packets may be used in various embodiments. For instance, some fields may have different lengths than the lengths indicated in FIG. 6. Additionally, other packet formats may be used, which may include a hop limit within a MAC header, though differing in some aspects from the specific formats of packets 520 and 600. In any event, the packets may be transmitted from device to device using MAC-layer addressing, and the hop limit values may be parsed and decremented before retransmission.

Further of note in this example is that the packets 520 and 600 do not include a destination address. This is because the packets 520 and 600 are broadcast packets, rather than unicast packets.

Various embodiments may include advantages over other solutions. For instance, the packets 520 and 600 may have reduced size compared to the packet 510. The reduced size may be a result of omitting some information that would otherwise be expected for higher layers in the stack, such as MPL, IP, UDP and/or the like. Thus, in one example, packet 510 may be around 100 bytes, but may be longer or shorter. By contrast, packets 520 and 600 may be as short as 20 bytes, depending upon the data being transmitted in payloads 523, 626. The reduced length may allow for quicker transmission as measured in the time domain. Quicker transmission may reduce latency, thereby improving reception time for devices one or more hops away from a source device. Such advantage becomes even more noticeable the more hops a packet has experienced. In some use cases, such as when packets 520, 600 may be used for reducing a power output of a device or shutting off a device, reduced latency may lead to better operation of a power network by reducing overloading of the network more quickly.

Furthermore, a given device in the network may handle (e.g., receive, transmit, re-transmit) multiple types of packets. For instance, in some implementations, packet 510 may be used ordinarily to transmit information, either unicast or broadcast, during normal operation. The same implementations may further use either or both of packets 520 and 600 for time critical broadcast packets. For example, a first node may transmit (e.g., broadcast) a first type of data (e.g., non-time critical) using packet 510 and may transmit time critical data using packet 520 or 600.

Time critical broadcast packets may be formatted to be recognized and may be recognized by their formats in some embodiments. For instance, in the example of packet 520, it includes a tag “TIME_CRIT_BROADCAST” in the field 522. Also, in the example of packet 600, the MAC layer in the protocol stack may be configured to recognize that packets having that specific format are time critical packets. In yet another embodiment, including a hop limit value in a MAC header, such as in field 522 of FIG. 5 or in field 623 of FIG. 6 may be considered an indicator of a time critical packet. In yet another example, an indication of time criticality may be included in any other appropriate field, and even in the MAC header 521 or 610 itself.

In some embodiments, from a network stack perspective, a specific, predetermined port may be used to address a specific type of time critical operation, e.g., “Port Number: 1234.” Then once the protocol stack of a receiver or transmitter sees a packet being sent to/from this port, the protocol stack may use such a special framing (e.g., as shown in FIG. 5) to send the packet bypassing regular protocol overheads. In fact, time criticality may be indicated using any appropriate technique.

In some embodiments, reserved time critical slots may be used for time critical packets. For example, FIG. 7 illustrates example time critical slots, according to various embodiments.

In the example of FIG. 7, there is an example time domain operation 700, which is repeated over time. A single repetition of the time domain operation 700 is labeled having slots 701-704. The slot 701 is a time critical slot. The time critical slot 701 immediately precedes the broadcast slot 702, which immediately precedes unicast slots 703 and 704.

In some embodiments, a special time period called “Time Critical Slots” (e.g., time critical slot 701) is used in which where only time critical packets (e.g., packets 520, 600) are to be sent. In some embodiments, such slots 701 may be used for non-time critical data but employing special treatment from interference or other perspective as well. In some embodiments, during time critical slots, such as slot 701, no other transmission (including asynchronous transmissions) are allowed from any device to ensure that packets sent in slot 701 are less vulnerable to interference. In some embodiments, such time critical slots 701 may be assigned to any position within a channel hopping operation. In some embodiments, the duration and quantity of such time critical slots may be increased to improve the latency achieved.

The time critical slots of time domain operation 700 are exemplary, though various embodiments may modify the time critical slots. For instance, a time critical slot may be placed between the broadcast slot 702 and the unicast slot 703 and 704, though there may be advantages to placing time critical slot 701 at the beginning of a repetition. For example, placing a time critical slot 701 immediately before the broadcast slot 702 may allow for a maximum amount of time for a time critical packet to traverse a number of hops. And as noted above, a given time domain operation may include multiple time critical slots, such as between broadcast slot 702 and unicast slot 703, after unicast slot 704, and/or the like. Also, the first repetition having slots 701-704, may be performed in a first channel of the frequency domain, a subsequent repetition may be performed in a second channel of the frequency domain, and on and on.

Continuing with the example of FIG. 7, a device may receive a packet, determine that the packet is a time critical packet, and then attempt to transmit the packet during a time critical slot (e.g., slot 701) in response to determining that the packet is a time critical packet. In an instance in which the attempt is successful, the device transmits the packet in slot 701. In an instance in which the attempt is unsuccessful (e.g., in response to detection that the channel is busy), the device may be configured to transmit the packet during the (e.g., immediately subsequent) broadcast slot 702 as a fallback option. As another example, a device may begin to transmit a time critical packet during slot 701 and finish transmitting the time critical packet during the slot 702.

In various embodiments, transmitting a packet in a time critical slot, such as slot 701, may include using channel sense multiple access-collision avoidance (CSMA-CA) techniques to make sure the channel is clear before transmitting in the slot 701. The use of CSMA-CA may work to avoid collision, but in some instances, may increase latency. Therefore, some embodiments may include omitting CSMA-CA for slots 701.

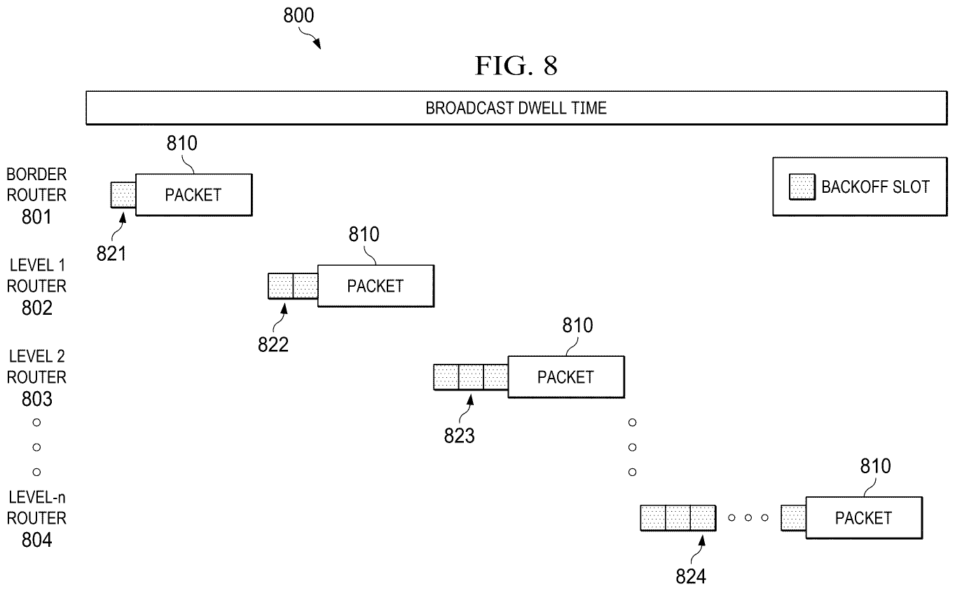

Similarly, some embodiments may use backoff slots (not shown but described with respect to FIG. 8), which may include, e.g., relatively small and randomly-determined time periods before transmitting in either the time critical slot 701 or the broadcast slot 702. For instance, a given device may apply a backoff slot immediately preceding the beginning of time critical slot 701 before transmitting a time critical packet in slot 701. Backoff slots may work to reduce collisions and may be used alone or in combination with other techniques, such as clear channel assessment (CCA) in CSMA-CA.

FIG. 8 is an illustration of an example time domain operation 800, according to some embodiments. FIG. 8 illustrates an example hierarchy of nodes, with the border router 801 being at the top of the hierarchy, a level 1 router 802 immediately following the border router 801, a level 2 router 803 immediately following the level 1 router 802, and ellipses to indicate that any appropriate number of other routers may be included, such as n, where n is an integer equal to or greater than one. The level n router 804 is shown at the bottom of the hierarchy.

During a broadcast dwell time, a packet 810 may be forwarded from the border router 801 through the other routers 802-804. An example of packet 810 may include any appropriate packet, such as an ordinary broadcast packet that may be forwarded from the border router 801 through the level n router 804 during the broadcast dwell time.

Backoff slots are illustrated for each of the layers in the hierarchy. As discussed above, a backoff slot may include a short time that may have some randomness. Furthermore, backoff slots may be stacked, so there may be multiple backoff slots applied by a given device. For instance, in this example, as the levels in the hierarchy go from the border router 801 to the level n router 804, the backoff slots are stacked to increase in quantity at each level. In this example, border router 801 is configured to use a single backoff slot 821. The level 1 router 802 is configured to stack two backoff slots 822. The level 2 router 803 is configured to stack 3 backoff slots 823, and the level n router 804 is configured to stack an appropriate quantity that may be greater than the three backoff slots at the level 2 router 803.

In practice, a device may implement the backoff slots by waiting for an elapsed time equal to its assigned quantity of backoff slots before transmitting packet 810. An example broadcast dwell time is illustrated in FIG. 1. In this example, the border router 801 may wait for a single backoff slot 821, and the downstream routers 802-804 would each receive the packet 801, wait their respective amount of back off slots, and forward the packet 810 to the next downstream router until the final router is reached or other condition is met to stop the retransmissions.

Some embodiments use of backoff slots to prioritize packets across different packet types and devices. Many protocols, including Wi-SUN, require a random wait time, such as backoff slots, and a CCA, to determine if the medium is free before transmitting a packet. Some embodiments use different backoff durations to enable different prioritization levels across packet types and devices.

FIG. 8 illustrates priority based on back off slots. As shown in FIG. 8, some embodiments determine the backoff slots to wait before sensing the channel and transmitting based on device type. For example, in some embodiments, the border router 801 has the least backoff slots. Subsequent devices may determine the number of backoff slots to wait based on their level in the network. Some embodiments, such as Wi-SUN-based embodiments, use RPL, and the network is formed like a tree and every device knows their RANK (or relative position from the border router 801). As shown in FIG. 8, in some embodiments, the number of backoff slots may be given by: backoff slots=Level in Hops+1.

Some embodiments prioritize and process first a time critical packet (e.g., packet 520, 600) even if there are other packets in the MAC queue. Some embodiments service a time critical packet even if in the middle of an asynchronous transmission where a device is transmitting back-to-back across multiple channels. In some such embodiments, the time critical packet is processed after completing the current packet transmission on the current channel and then the asynchronous transmission is resumed or restarted once this packet transmission of the critical packet has been completed.

Some embodiments ensure that devices use a minimum backoff duration that is higher than the highest backoff duration determined based on MAC levels supported in a network for ordinary packets. Such process may ensure that ordinary packets do not interfere with the transmission of time critical packets.

In some embodiments, if a device senses the channel to be busy after waiting for the assigned backoff slots, the device may drop the packet and not attempt to transmit the packet, e.g., to limit a potential broadcast storm.

The embodiment of FIG. 8 may differ from Priority Channel Access (PCA) in IEEE 802.15.4-2020. For instance, the example embodiment of FIG. 8 does not just assign a lower channel access delay for transmitting time critical packets. Additionally, the example embodiment of FIG. 8 may enable different priority levels across multiple hops and devices, may use priority queuing to place the time critical packet at head of queue, and acts as a way to limit broadcast storms.

In one example, a device may receive a packet from another device (e.g., the level 1 router 802 may receive a packet from the border router 801). The receiving device may then determine whether the packet is a time critical packet. Should the device determine that the packet is a time critical packet, then the device may exempt the packet from waiting for a backoff time period. In the example of FIG. 8, the level 1 router 802 may determine that a packet is a time critical packet and may then exempt that time critical packet from its stack of backoff slots 822. The other devices 801, 803, 804 may behave similarly. However, should a device determine that a packet is not a time critical packet, then it may apply its assigned stack of backoff slots.

Continuing with the example, the device may apply an interference mitigation technique, such as performing a CCA, and determine that the channel is free prior to transmitting the packet. This may be true whether or not the device determines that the packet is time critical. Additionally, each of the devices 801-804 may handle a variety of different packets, some ordinary and some time critical. Accordingly, each of the devices 801-804 may determine whether a given packet is time critical and then either apply the backoff slot operation (for ordinary packets) illustrated in FIG. 8 or exempt a time critical packet from backoff slots.

While described for broadcast packets in FIG. 8, the use of backoff slots to prioritize packets across different packet types and devices may also be applied for unicast packets.

Some embodiments may prioritize time critical packets. For example, some embodiments take time critical packet as head of queue (e.g., either transmit or processing) even after an end of current packet processing. On receiving a packet that it determines to be time critical, on the MAC receive side, the device may place the packet to head of queue and start processing immediately, even before processing other packets.

In one example, a method of operation for a device (e.g., any of routers 801-804 of FIG. 8) may include receiving a packet, determining whether the packet is a time critical packet, and then moving the packet to the front of a transmission queue based on whether the packet is a time critical packet. For instance, the device may move the packet to the front of the transmission queue in response to determining that the packet is a time critical packet; otherwise, the device may handle the packet in its ordinary course.

In another example, a device may receive a packet, determine whether the packet is a time critical packet, and then move the packet to the front of a processing queue based on whether the packet is a time critical packet. For instance, the device may move the packet to the front of the processing queue in response to determining that the packet is a time critical packet; otherwise, the device may process the packet in its ordinary course.

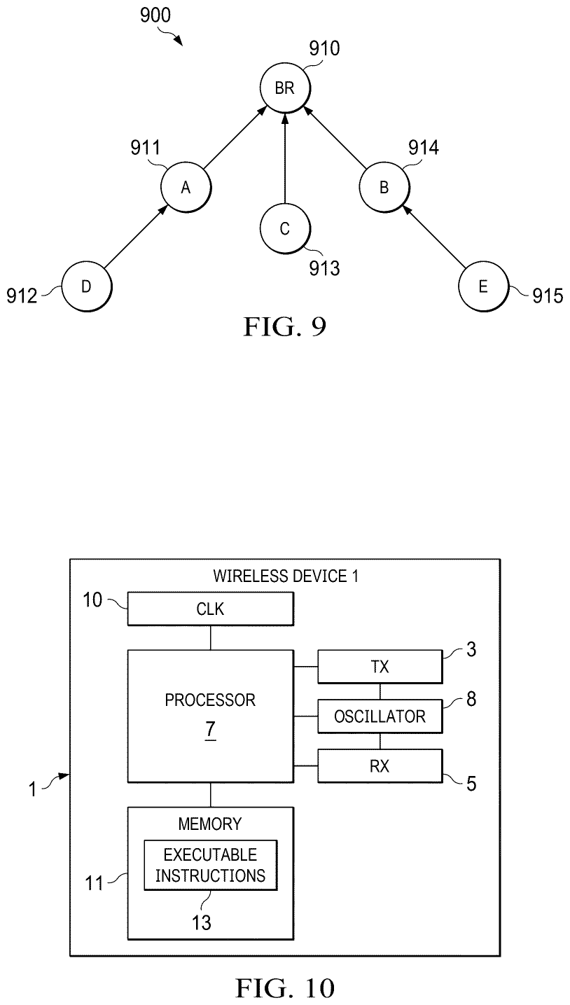

FIG. 9 is an illustration of an example tree 900 of devices 910-915. In one example, the border router 910 may be the same as or similar to the border router 801 of FIG. 8. Devices 911, 913, and 914 are one hop away from the border router 910 and are, thus, level 1 routers. Devices 912 and 915 are two hops away from the border router 910 and, thus, are level 2 routers. The arrows from one device to another indicate a direction of increase in the hierarchy of the tree 900. In one example, router 912 is a child router of router 911, as router 912 communicates to border router 910 via router 911. Similarly, router 915 may be a child router of 914 because router 915 communicates to border router 910 via router 914. Routers 912, 913, and 915 do not have any child routers.

Further in this example, the border router 910 may include nonvolatile memory in which it stores data indicating the structure of tree 900, e.g., so that the border router 910 is aware of the arrangement of the devices 910-915. Each of the devices 911-915 may also include nonvolatile memory to store data indicating at least a part of the structure of tree 900. However, a given one of the devices 911-915 may not be aware of the entirety of the structure of the tree 900. For instance, router 911 may be aware of border router 910 and router 912 but may not be aware of router 913 or routers 914-915. Similarly, router 914 may be aware of router 910 and 915 but may not be aware of routers 911-913. Router 913 may be aware of border router 910 but may not be aware of any of the other routers 911, 912, 914, 915.

Of course, the tree 900 is exemplary, and other implementations may include any appropriate structure that may include more devices or fewer devices, more child devices or fewer child devices.

Some embodiments use pre-configured or in-packet specified selective forwarding through a routing tree, such as tree 900. One challenge with broadcast packets is that once the packet is received by devices, all devices that receive the packet may be required to retransmit it to ensure the packet propagates to all devices. Such scenario may cause a broadcast storm. Some ways exist to limit broadcast storms (that is, to limit the number of devices that have to rebroadcast to get the packets across multiple hops). For example, MPL uses trickle timers to allow devices to hear each other and limit transmissions based on whether transmission of a specific packet is observed. However, trickle timers may exhibit longer delays, making such a method difficult to use for meeting low latency needs. The use of backoff slots to prioritize packets across different packet types and devices may limit the latency but may cause increased collision in large networks if let to work as the only method.

By contrast, some embodiments may use a method of selective forwarding, which includes configuring the border router 910 to assign which of the devices 911-915 may re-broadcast a given time critical packet based on its knowledge on the network. Such a selection may include redundancy to account for packet failures to target devices.

For example, some networks, such as Wi-SUN, form a tree-based topology, such as shown in tree 900. The border router 910 may have full knowledge of the topology and hence may determine which ones of the nodes 911-915 should re-broadcast a given time critical packet to get desired coverage.

For example, consider a sample topology shown as tree 900 in FIG. 9. In FIG. 9, ideally, only devices 911 and 914 need to rebroadcast the packet to ensure coverage to all devices in network. Since border router 910 (central device to whom all devices join to using RPL routing protocol, e.g., as defined in Wi-SUN specification) knows the entire network topology, the border router 910 may determine the optimal set of forwarding devices (e.g., devices 911 and 914 in the example of FIG. 9). Once determined, the border router 910 may send this information to the devices 911-915 either through separate message or by including the respective addresses of those devices selectively inside the time critical packet itself. Upon receiving a packet to rebroadcast, only those devices attempt to rebroadcast, thereby advantageously reducing the number of contending devices.

In some embodiments, the selective forwarding method may additionally be combined with priority based on back off slots method (e.g., illustrated in FIG. 8) by additionally specifying the number of backoff slots to use before attempting transmission and number of channel access failures to wait for before dropping the packet from further processing. Such technique may help further tune the network to configure which devices to rebroadcast and with what delay to optimize overall time it takes to propagate the broadcast packet info to entire network.

In one example method, a device, such as any of devices 911-915, may receive a broadcast packet and then forward the packet in response to determining whether that device has a child device. For instance, each device 911-915 may include non-volatile memory in which it stores data indicating at least part of the tree 900, and a given one of the devices 911-915 may know whether it has child devices to which it may forward a packet. Thus, the device may determine whether it has a child device and may then, assuming it determined that has a child device, transmit the packet to the child device. Otherwise, the device may omit forwarding the packet. Examples of packets that may be forwarded include ordinary packets and also time critical packets, such as packets 520 and 600.

In yet another example, the device may receive the packet and then parse the packet. By virtue of parsing the packet, the device may determine that the packet includes a forwarding indication. The forwarding indication may include data in a header (e.g., header 511 or 521) or a field within such header, and the forwarding indication may be included in the packet by an upstream router, such as border router 910. In response to determining that the packet includes a forwarding indication, the device may forward the packet to any available child devices.

In another example, an upstream device, such as border router 910, may include addresses of downstream devices as a forwarding indicator. Upon receiving the packet, a given downstream device may parse the packet, search the contents of the packet for its own address (e.g., a MAC address) and then either forward the packet or not forward the packet based upon whether its address is included in the packet. In other words, a downstream device may determine that it is a forwarding device based upon whether it finds its own address included in the packet. In one example, router 911 may parse the packet and determine that its own address is included in the packet and then forward the packet based on that determination. However, router 912 may parse the packet, not see its own address within the packet, and not forward the packet based on determining that its address is not within the packet.

As noted above, FIG. 4 describes an asynchronous transmission. Additionally or alternatively to other techniques described herein, some embodiments may limit asynchronous packet transmission based on reserved slots or incoming time critical packets. Asynchronous packets, which are sent back-to-back on different channels, may cause an ongoing transmission to fail. Furthermore, a device that is performing asynchronous transmission may not be able to receive an incoming transmission until it finishes the entire asynchronous transmission, which may be in the order of several 10s of ms (sometimes even exceeding the latency requirement). In other words, asynchronous transmissions may cause delays which in some instances may disadvantageously cause latency for time critical packets.

Some embodiments may limit asynchronous packet transmission by preventing asynchronous transmissions during the dedicated transmission slots (e.g., slots 701 of FIG. 7), and/or forcing a delay on asynchronous transmissions equal to the maximum backoff between transmissions. In some embodiments, if at any point a device receives an incoming packet, the device may prioritize reception of incoming packets. Should the device determine that an incoming packet is a time critical packet, the device may suspend any asynchronous transmission and may start to process the time critical packet.

In one example, a device may be operating according to a protocol having repeating sets of slots, such as illustrated in FIG. 7. The repeating slots may include a time critical slot 701, broadcast slot 702 and one or more unicast slot 703, 704. The device may receive a packet, determine that the packet is a time critical packet, and then transmit the packet in a time critical slot. However, during a subsequent repetition of the set of slots, the device may determine to send an asynchronous transmission in response to an absence of any time critical packet being received by that device.

In one example, the device may transmit the asynchronous transmission in the broadcast slot 702 after a backoff duration. Example backoff durations are shown in FIG. 8, and in some instances, the device may apply a backoff duration according to its level in the hierarchy or may apply a maximum backoff duration in response to determining that its transmission is an asynchronous transmission. An example method may include applying the backoff duration for the asynchronous transmission, receiving a subsequent packet during the backoff duration, determining whether the subsequent packet is a time critical packet, and then suspending the asynchronous transmission and processing the subsequent packet in response to determining that the subsequent packet is a time critical packet. Once the device has handled the time critical packet appropriately (e.g., by processing and/or forwarding the packet), the device may resume the asynchronous transmission.

Some embodiments may enable unicast packets to be sent during broadcast slots and use only broadcast hopping for entire network, which may advantageously enable low or zero wait time before a time critical broadcast packet may be taken up for processing. In the Wi-SUN specification, unicast packets are sent during unicast slots and broadcast packets are sent during broadcast slots. If the objective of a network is to support time critical broadcast packets, then the time spent in unicast slots (broadcast interval-broadcast dwell time) may impact the average and worst-case achievable latency. In some embodiments, broadcast interval is set to be equal to broadcast dwell time so that the system is completely in broadcast hopping mode. In some embodiments, the system is still able to get the benefit of channel hopping as the channel of broadcast dwell time changes with each repetition of the set of slots. An example of such an embodiment may include that it enables a lowest wait time, perhaps zero, before a time critical broadcast packet may be taken up for processing and transmitting by a given device.

Some embodiments enable unicast packets to be sent during broadcast dwell time using the broadcast channel itself, e.g., to enable normal network operation.

In one example, a device may operate according to a protocol in which a set of slots repeats in a time domain and across a plurality of channels in a frequency domain, though that protocol may omit unicast-specific slots. A device, operating according to the protocol, may transmit a packet during a broadcast slot in the set of slots, where that packet may include an ordinary packet or a time critical packet, such as packets 520 and 600.

FIG. 10 shows a block diagram of an example device 1, according to an embodiment. In some embodiments, any of the devices referred to herein may be implemented as device 1. For instance, the nodes, routers, and other devices, such as discussed above with respect to FIGS. 1-9 and 11-12 may be implemented as device 1.

In some embodiments, device 1 includes transmitter 3 and receiver 5. Transmitter 3 may be, for example, a radio frequency (RF) transmitter. Receiver 4 may be, for example, an RF receiver. Device 1 has an oscillator 8 for generating RF signals. Oscillator 8 may include, for example, phase-locked loops (PLLs), e.g., capable of generating sine waves. Device 1 may also include a processor 7, a memory 11 and a clock 10. Memory 11 may include executable instructions 13 and may include a non-transitory storage device such as volatile memory (e.g., random access memory) or non-volatile memory (e.g., read only memory).

In one example, device 1 may store computer-executable instructions 13, which may be configured to cause device 1 to function according to the principles discussed with respect to FIGS. 1-9 and 11-12. Specifically, the processor 7 may read and execute the instructions 13 to provide functionality discussed above with respect to FIGS. 1-9 and 11-12.

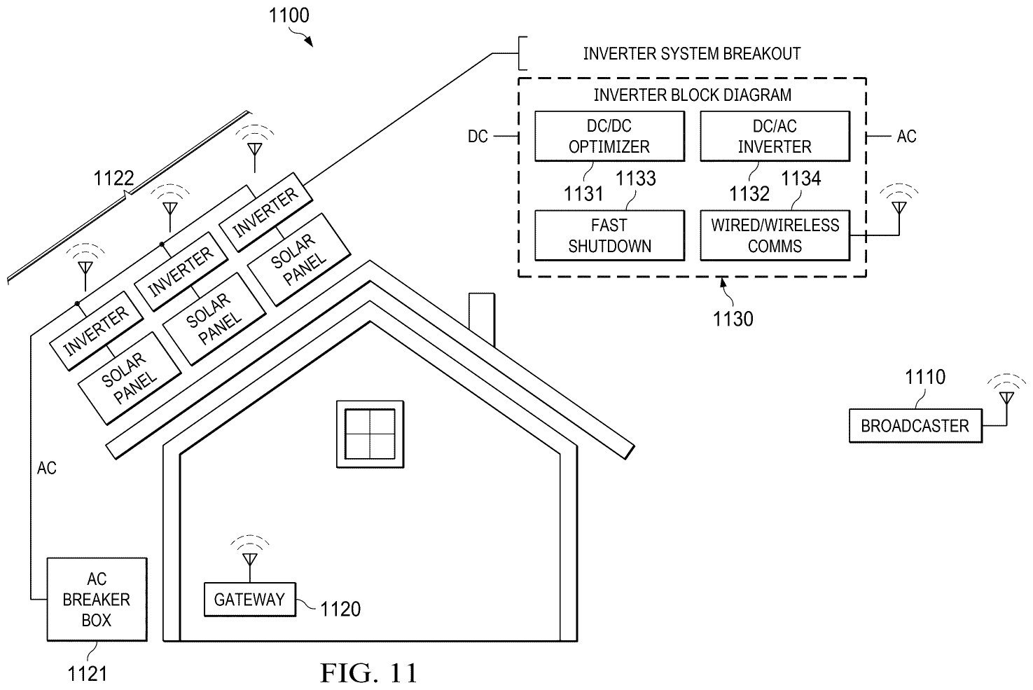

FIG. 11 illustrates example system 1100, adapted according to some embodiments. System 1100 includes a broadcaster device 1110, which may be implemented as a device, such as any of devices 801-804 and 910-915. For purposes of this example, broadcaster 1110 may broadcast a message over a wireless medium, and that message may be received by gateway 1120. In some embodiments, broadcaster 1110 may send the message directly to gateway 1120. In some embodiments, broadcaster 1110 may send the message via a wired medium, such as using fiber optics.

Further in this example, gateway 1120 may be configured to transmit the message received from broadcaster 1110 (or a message based on the message received from broadcaster 1110) to the array of inverters and solar panels 1122, in a manner such as described with respect to FIGS. 1-9.

In some embodiments, the array of solar panels 1122 includes inverters, an example of which is shown in more detail as inverter system 1130. Inverter system 1130 includes wireless or wired communication system 1134, power converter circuitry 1131-1132, and fast shut down circuitry 1133. In one example, each of the inverters of the array 1122 may be configured to receive a message from e.g., gateway 1120, and take action based on the content of the message. For instance, the broadcaster 1110 may transmit a time critical packet (e.g., packet 520 or 600) configured to instruct a receiving device to either reduce a power output or shut down. Each device, upon reception of the time critical message, may perform the requested action, and then forward/broadcast the message to other nodes. The gateway 1120 may be a device one or more hops away from the broadcaster 1110, and the gateway 1120 may be configured to receive messages and transmit messages based on the received messages, such as forwarding those messages to the array 1122. The inverters of the array 1122 in one example may receive a time critical message via their respective wired or wireless communication systems 1134, parse that message, and in response utilize fast shut down circuitry 1133 to shut down power output to the AC breaker box 1121 or perhaps reduce a power supplied to the AC breaker box 1121.

The broadcaster 1110, the gateway 1120, and the inverters' wireless communication systems 1134 may originate a message, forward a received or original message, and/or take action based on content of the message. In other words, each of the broadcaster 1110, the gateway 1120, and the wireless communication systems 1134 may be configured as any of the devices 801-804 and 910-915 and configured to perform the actions described above with respect to FIGS. 1-9 and 12. Furthermore, each of the broadcaster 1110, the gateway 1120, and the wireless communications systems 1134 may be configured as described above with respect to FIG. 10.

In some embodiments, each of devices 1120 and 1130 may include device 1.

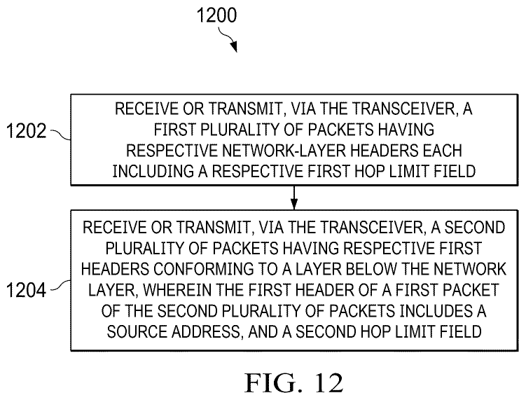

FIG. 12 is an illustration of example method 1200, adapted according to some embodiments. Method 1200 may be performed by any of devices 801-804, 910-915, 1110, 1120, and 1130 to perform the functionality described above with respect to FIGS. 1-9. In one example, one or more processors (e.g., processor 7) may read and execute computer-executable instructions (e.g., instructions 13) from computer readable media (e.g., memory 11) to perform the actions of method 1200.

At action 1202, the device receives or transmits, via a transceiver, a first plurality of packets having respective network-layer headers each including a respective first hop limit field. An example is discussed above with respect to FIG. 5, where packet 510 represents a packet that may be used in the ordinary course of operation by a device in a frequency-hopping network. An example of such a network may include a Wi-SUN network, however, the scope of implementations is not limited to any particular protocol.

In one example, the network-layer headers may include IP headers. The headers may conform to a network-layer protocol and allow the network-layer functionality to receive, parse, reconstruct, format, or transmit such packets. Various embodiments may include a protocol stack, which provides functionality for other protocol stack layers. For instance, a given protocol stack may include a transport layer (e.g., UDP/TCP), a network layer (e.g., an IP layer, such as discussed above), a data link layer (e.g., a MAC layer), and a physical layer (e.g., PHY layer). In the example of FIG. 5, the packet 510 includes a UDP header 514, and IP header 513, a MPL header 512 (which may be considered to be below IP in the protocol stack), and MAC header 511. The application payload 515 may correspond to an application layer, which may be above the transport layer in the protocol stack.

In this example, the headers of action 1202 may include a multitude of data, each piece of data corresponding to the various layers of the packet. By contrast, the packets 520 and 600 may be directed specifically to the data link layer (e.g., MAC layer) and may omit information specific to layers above the data link layer. As a result, packets 520 and 600 may have less data and may be able to be received, processed, and transmitted more quickly than would be expected of packet 510.

At action 1204, the device receives or transmits, via the transceiver, a second plurality of packets. The second plurality of packets may have respective first headers conforming to a layer below the network layer, wherein the first header of a first packet of the second plurality of packets includes a source address and a second hop limit field.

Examples of packets that conform to the second plurality of packets include packets 520 and 600. Specifically, packets 520 and 600 have MAC headers, each of those MAC headers including hop limit fields and source address fields. In the example of packet 520, the hop limit field is in field 522 within MAC header 521. In the example of packet 600, the hop limit field 623 is included in the vendor payload field 620 within the MAC header 610.

Of note in method 1200 is that the device may participate in a network in which multiple types of packets may be generated, processed, received, and transmitted by the various devices. For instance, a given device may be able to handle both ordinary packets and time critical packets as appropriate.

The scope of implementations is not limited to the actions specifically illustrated in FIG. 12. For instance, other implementations may add, omit, rearrange, or modify various actions. In one example, method 1200 may further include the device parsing a given packet and performing an action based upon the contents of the packet. For instance, a packet, such as packet 510, may be configured to include control plane information that may not necessarily be time critical. A given device may receive such a packet, parse the packet and process the packet, and in response to the contents of the packet perform some action. In another example, a packet, such as packet 520 or packet 600, may be configured to include time critical information, such as information that may indicate to a specific device to change its operation. An example is discussed above the respect to FIG. 11, where an inverter may be controlled to reduce its output or shut down based on data in a packet. For instance, various time critical packets may be received by the device, parsed, and based on the contents of the packet, may shut down or reduce a power output.

Example embodiments of the present disclosure are summarized here. Other embodiments can also be understood from the entirety of the specification and the claims filed herein.

Example 1. A method including: formatting data into a packet that includes: a medium access control (MAC) header and a payload, the MAC header having a source MAC address and an identifier of a hop limit; and transmitting the packet.

Example 2. The method of example 1, where the method is performed by a device having the source MAC address and a networking address, where the packet does not include the networking address.

Example 3. The method of one of examples 1 or 2, where the method is performed by a device having the source MAC address and a networking address, where the MAC header includes the networking address.

Example 4. The method of one of examples 1 to 3, where the identifier of the hop limit indicates a maximum quantity of retransmissions of the packet.

Example 5. The method of one of examples 1 to 4, where the packet does not include a destination address.

Example 6. The method of one of examples 1 to 5, where the MAC header includes a vendor payload information element (IE), and where the vendor payload IE includes the source MAC address, the identifier of the hop limit, and the payload.

Example 7. The method of one of examples 1 to 6, where the vendor payload IE includes a vendor ID field, where the vendor ID field includes data configured to identify how to interpret contents of the vendor payload IE.

Example 8. The method of one of examples 1 to 7, where the payload includes data configured to shut down a device or reduce a voltage of the device, the method further including: parsing the payload; and shutting down the device or reducing the voltage of the device in response to the payload.

Example 9. The method of one of examples 1 to 8, where the MAC header further includes packet duplicate detection information.

Example 10. The method of one of examples 1 to 9, where the MAC header includes data identifying the packet as time critical.

Example 11. The method of one of examples 1 to 10, where the payload includes data identifying the packet as time critical.

Example 12. The method of one of examples 1 to 11, where formatting the data into the packet includes: receiving the packet from a first device; and decrementing the identifier of the hop limit to generate a decremented hop limit, where transmitting the packet includes transmitting the packet having the decremented hop limit.

Example 13. The method of one of examples 1 to 12, further including: receiving the packet from a device; and determining to transmit the packet based on parsing the identifier of the hop limit and comparing the identifier of the hop limit to a threshold.

Example 14. The method of one of examples 1 to 13, further including operating according to a protocol in which a set of slots repeats in a time domain, where the set of slots includes a broadcast slot, a unicast slot, and a time critical slot, where transmitting the packet includes: attempting to transmit the packet during the time critical slot in response to determining that the packet is a time critical packet; and in response to failing to transmit the packet during the time critical slot, transmitting the packet during the broadcast slot.

Example 15. The method of one of examples 1 to 14, where attempting to transmit the packet during the time critical slot includes attempting to transmit the packet using channel sense multiple access-collision avoidance (CSMA-CA).

Example 16. The method of one of examples 1 to 15, further including: operating according to a protocol in which a set of slots repeats in a time domain, where the set of slots includes a broadcast slot, a unicast slot, and a time critical slot, where transmitting the packet includes transmitting the packet in the time critical slot in response to determining that the packet is a time critical packet.

Example 17. The method of one of examples 1 to 16, where transmitting the packet in the time critical slot includes transmitting the packet in the time critical slot after a random back-off time from the start of the time critical slot has elapsed.

Example 18. The method of one of examples 1 to 17, where in the time domain, the time critical slot immediately precedes the broadcast slot.

Example 19. The method of one of examples 1 to 18, where transmitting the packet includes transmitting a portion of the packet during the broadcast slot.

Example 20. The method of one of examples 1 to 19, where the unicast slot immediately follows the broadcast slot.

Example 21. The method of one of examples 1 to 20, where a first repetition of the set of slots is performed in a first channel of a frequency domain, and in which a subsequent repetition of the set of slots is performed in a second channel of the frequency domain.

Example 22. The method of one of examples 1 to 21, further including: receiving the packet from a device; determining whether the packet is a time critical packet; and moving the packet to a front of a transmission queue based on whether the packet is a time critical packet.

Example 23. The method of one of examples 1 to 22, further including: receiving the packet from a device; determining whether the packet is a time critical packet; and moving the packet to a front of a processing queue based on whether the packet is a time critical packet.

Example 24. The method of one of examples 1 to 23, further including: receiving the packet from a device; determining whether the packet is a time critical packet; and exempting the packet from waiting for a backoff time period in response to determining whether the packet is a time critical packet.

Example 25. The method of one of examples 1 to 24, further including: receiving another packet from the device; and in response to determining that the another packet is not a time critical packet, transmitting the another packet after waiting for a random backoff time.

Example 26. The method of one of examples 1 to 25, further including: determining whether a clear channel assessment (CCA) is successful prior to transmitting the packet.

Example 27. The method of one of examples 1 to 26, further including: for a subsequent packet, determining that the subsequent packet is not a time critical packet; and applying a backoff time period, based on a rank of a device performing the transmitting, to the subsequent packet.

Example 28. The method of one of examples 1 to 27, further including: determining that a device performing the transmitting has a child device; and transmitting the packet in response to determining that the device has the child device.

Example 29. The method of one of examples 1 to 28, further including receiving, by a device, a forwarding indication from a router to perform rebroadcasting, where transmitting the packet includes transmitting the packet in response to the forwarding indication.

Example 30. The method of one of examples 1 to 29, where the forwarding indication is included in the packet.

Example 31. The method of one of examples 1 to 30, where the forwarding indication includes an address of the device.

Example 32. The method of one of examples 1 to 31, further including: parsing the packet to determine whether data in the packet indicates that a device performing the transmitting is a forwarding device; and transmitting the packet in response to determining whether the device is a forwarding device.

Example 33. The method of one of examples 1 to 32, further including: determining that the device is a forwarding device based upon determining that a MAC address of the device is included in the packet.

Example 34. The method of one of examples 1 to 33, further including: operating according to a protocol in which a set of slots repeats in a time domain, where the set of slots includes a broadcast slot, a unicast slot, and a time critical slot, where transmitting the packet is performed in the time critical slot; and during a subsequent repetition of the set of slots, determining to send an asynchronous transmission.

Example 35. The method of one of examples 1 to 34, further including: sending the asynchronous transmission in the broadcast slot after a backoff duration.

Example 36. The method of one of examples 1 to 35, further including: applying a backoff duration for the asynchronous transmission; receiving a subsequent packet during the backoff duration; determining whether the subsequent packet is a time critical packet; and suspending the asynchronous transmission and processing the subsequent packet in response to determining whether the subsequent packet is a time critical packet.

Example 37. The method of one of examples 1 to 36, further including: operating according to a protocol in which a set of slots repeats in a time domain and across a plurality of channels in a frequency domain, further in which the protocol omits unicast-specific slots, where transmitting the packet includes transmitting the packet during a broadcast slot in the set of slots.

Example 38. The method of one of examples 1 to 37, further including: subsequent to transmitting the packet, receiving a subsequent packet including a network-layer header, a transport-layer header, and a second MAC header, where the network-layer header includes a second identifier of a second hop limit; and transmitting the subsequent packet to another device according to a destination identified in the network-layer header and a port identified in the transport-layer header.

Example 39. An electronic device including: a transceiver; and a processor configured to: receive or transmit, via the transceiver, a first plurality of packets having respective network-layer headers each including a respective first hop limit field; and receive or transmit, via the transceiver, a second plurality of packets having respective first headers conforming to a layer below the network layer, where the first header of a first packet of the second plurality of packets includes a source address, and a second hop limit field.

Example 40. The electronic device of example 39, where the processor is configured to forward the first packet to another electronic device based on a value in the second hop limit field of the first header of the first packet indicating a further hop.

Example 41. The electronic device of one of examples 39 or 40, where the processor is configured to decrement a value in the second hop limit field and forward the first packet having the decremented value to another electronic device.

Example 42. The electronic device of one of examples 39 to 41, where the first packet does not include a network-layer header.

Example 43. The electronic device of one of examples 39 to 42, where the layer below the network layer includes a medium access control (MAC) layer, and where the source address is a MAC address.

Example 44. The electronic device of one of examples 39 to 43, where the network layer includes an Internet protocol (IP) layer, and where the source address includes an IP address.

Example 45. The electronic device of one of examples 39 to 44, where the first packet includes an indication that the packet is a time critical packet.

Example 46. The electronic device of one of examples 39 to 45, where the first packet includes data indicating that a device should be shut off or an operational parameter of the device be reduced.

Example 47. The electronic device of one of examples 39 to 46, where the processor is configured to: shut off the device or reduce the operational parameter of the device based on the data; and either forward the first packet or not forward the first packet based on a value in the second hop limit field indicating a further hop or no further hop.

Example 48. The electronic device of one of examples 39 to 47, where the processor is configured to: operate according to a protocol in which a set of slots repeats and a time domain, where the set of slots includes a broadcast slot, a unicast slot, and a time critical slot; and transmit the first packet in the time critical slot based on a value in the second hop limit field indicating a further hop.

Example 49. The electronic device of one of examples 39 to 48, where the protocol includes a channel hopping protocol, further where the time critical slot immediately precedes the broadcasting slot in the time domain, and where the unicast slot immediately follows the broadcast slot.

Example 50. The electronic device of one of examples 39 to 49, where the processor is configured to: determine whether the first packet is a time critical packet; and move the first packet to a front of a transmission queue based on whether the first packet is a time critical packet.

Example 51. The electronic device of one of examples 39 to 50, where the processor is configured to: determine whether the first packet is a time critical packet; and move the first packet to a front of a processing queue based on whether the first packet is a time critical packet.

Example 52. The electronic device of one of examples 39 to 51, where the processor is configured to: exempt the packet from waiting for a backoff time period in response to determining whether the packet is a time critical packet.

Example 53. The electronic device of one of examples 39 to 52, where the processor is further configured to: for a second packet, of the first plurality of packets, determine that the second packet is not a time critical packet; and apply a backoff time period to the second packet, based on a rank of the electronic device.

Example 54. The electronic device of one of examples 39 to 53, where the processor is configured to: parse the first packet to determine whether data in the first packet indicates that the electronic device is a forwarding device; and transmit the first packet in response to determining whether the electronic device is a forwarding device and based on a value in the second hop limit field indicating a further hop.

Example 55. The electronic device of one of examples 39 to 54, where the processor is configured to determine whether the data in the first packet indicates that the electronic device is a forwarding device by determining whether an address of the electronic device is included in the data.

Example 56. The electronic device of one of examples 39 to 55, where the processor is configured to: transmit the first packet in a slot dedicated to time critical broadcast based on a value in the second hop limit field indicating a further hop; subsequent to transmitting the first packet, determined to send an asynchronous transmission; apply a backoff duration for the asynchronous transmission; receive a second packet during the backoff duration; determine whether the second packet is a time critical packet; and suspend the asynchronous transmission and process the second packet in response to determining whether the second packet is a time critical packet.

Example 57. The electronic device of one of examples 39 to 56, where the processor is further configured to: operate according to a protocol in which a set of slots repeats in a time domain and across a plurality of channels in a frequency domain, further in which the protocol omits unicast-specific slots, where the processor is configured to transmit the first packet during a broadcast slot in the set of slots.

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A method comprising:
formatting data into a packet that includes: a medium access control (MAC) header and a payload, the MAC header having a source MAC address and an identifier of a hop limit; and
transmitting the packet.

2. The method of claim 1, wherein the method is performed by a device having the source MAC address and a networking address, wherein the packet does not include the networking address.

3. The method of claim 1, wherein the method is performed by a device having the source MAC address and a networking address, wherein the MAC header includes the networking address.

4. The method of claim 1, wherein the packet does not include a destination address.

5. The method of claim 1, wherein the MAC header includes a vendor payload information element (IE), and wherein the vendor payload IE includes the source MAC address, the identifier of the hop limit, and the payload, and further wherein:
the vendor payload IE includes a vendor ID field, and the vendor ID field includes data configured to identify how to interpret contents of the vendor payload IE.

6. The method of claim 1, wherein the MAC header further includes packet duplicate detection information.

7. The method of claim 1, wherein the MAC header includes data identifying the packet as time critical, and wherein the payload includes the data identifying the packet as time critical.

8. The method of claim 1, wherein formatting the data into the packet comprises:
receiving the packet from a first device;
determining to transmit the packet based on parsing the identifier of the hop limit and comparing the identifier of the hop limit to a threshold; and
decrementing the identifier of the hop limit to generate a decremented hop limit, wherein transmitting the packet includes transmitting the packet having the decremented hop limit.

9. The method of claim 1, further comprising operating according to a protocol in which a set of slots repeats in a time domain, wherein the set of slots includes a broadcast slot, a unicast slot, and a time critical slot, wherein transmitting the packet comprises:
attempting to transmit the packet during the time critical slot in response to determining that the packet is a time critical packet; and
in response to failing to transmit the packet during the time critical slot, transmitting the packet during the broadcast slot.

10. The method of claim 1, further comprising:
operating according to a protocol in which a set of slots repeats in a time domain, wherein the set of slots includes a broadcast slot, a unicast slot, and a time critical slot, wherein transmitting the packet comprises transmitting the packet in the time critical slot after a random back-off time from the start of the time critical slot has elapsed.

11. The method of claim 1, further comprising:
operating according to a protocol in which a set of slots repeats in a time domain, wherein the set of slots includes a broadcast slot, a unicast slot, and a time critical slot, wherein transmitting the packet comprises transmitting the packet in the time critical slot in response to determining that the packet is a time critical packet and wherein in the time domain, the time critical slot immediately precedes the broadcast slot and the unicast slot immediately follows the broadcast slot.

12. The method of claim 11, wherein transmitting the packet comprises transmitting a portion of the packet during the broadcast slot.

13. The method of claim 1, further comprising:
operating according to a protocol in which a set of slots repeats in a time domain, wherein the set of slots includes a broadcast slot, a unicast slot, and a time critical slot, wherein transmitting the packet comprises transmitting the packet in the time critical slot in response to determining that the packet is a time critical packet and wherein a first repetition of the set of slots is performed in a first channel of a frequency domain, and in which a subsequent repetition of the set of slots is performed in a second channel of the frequency domain.

14. The method of claim 1, further comprising:
receiving the packet from a device;
determining whether the packet is a time critical packet; and
moving the packet to a front of a processing queue based on whether the packet is a time critical packet; or
moving the packet to a front of a transmission queue based on whether the packet is a time critical packet.

15. The method of claim 1, further comprising:
receiving the packet from a device;
determining whether the packet is a time critical packet;
exempting the packet from waiting for a backoff time period in response to determining whether the packet is a time critical packet;
receiving another packet from the device; and
in response to determining that the another packet is not a time critical packet, transmitting the another packet after waiting for a random backoff time.

16. The method of claim 1, further comprising:
receiving the packet from a device;
determining whether the packet is a time critical packet;
exempting the packet from waiting for a backoff time period in response to determining whether the packet is a time critical packet
for a subsequent packet, determining that the subsequent packet is not a time critical packet; and
applying a backoff time period, based on a rank of a device performing the transmitting, to the subsequent packet.

17. The method of claim 1, further comprising:
determining that a device performing the transmitting has a child device; and
transmitting the packet in response to determining that the device has the child device.

18. The method of claim 1, further comprising receiving, by a device, a forwarding indication from a router to perform rebroadcasting, wherein transmitting the packet comprises transmitting the packet in response to the forwarding indication, wherein the forwarding indication is included in the packet, and wherein the forwarding indication comprises an address of the device.

19. The method of claim 1, further comprising:
parsing the packet to determine whether data in the packet indicates that a device performing the transmitting is a forwarding device; and
transmitting the packet in response to determining whether the device is a forwarding device.

20. The method of claim 19, further comprising: determining that the device is a forwarding device based upon determining that a MAC address of the device is included in the packet.

21. The method of claim 1, further comprising:
operating according to a protocol in which a set of slots repeats in a time domain, wherein the set of slots includes a broadcast slot, a unicast slot, and a time critical slot, wherein transmitting the packet is performed in the time critical slot; and
during a subsequent repetition of the set of slots, determining to send an asynchronous transmission.

22. The method of claim 21, further comprising:
sending the asynchronous transmission in the broadcast slot after a backoff duration.

23. The method of claim 21, further comprising:
applying a backoff duration for the asynchronous transmission;
receiving a subsequent packet during the backoff duration;
determining whether the subsequent packet is a time critical packet; and
suspending the asynchronous transmission and processing the subsequent packet in response to determining whether the subsequent packet is a time critical packet.

24. The method of claim 1, further comprising:
operating according to a protocol in which a set of slots repeats in a time domain and across a plurality of channels in a frequency domain, further in which the protocol omits unicast-specific slots,
wherein transmitting the packet includes transmitting the packet during a broadcast slot in the set of slots.

25. The method of claim 1, further comprising:
subsequent to transmitting the packet, receiving a subsequent packet including a network-layer header, a transport-layer header, and a second MAC header, wherein the network-layer header includes a second identifier of a second hop limit; and
transmitting the subsequent packet to another device according to a destination identified in the network-layer header and a port identified in the transport-layer header.
